(19) United States
(12) Patent Application Publication
(10) Pub. No.: US 2013/0206891 A1
(43) Pub. Date: Aug. 15, 2013

(54) REEL HANGER CLIP

(71) Applicant: Jared Hendricks, Draper, UT (US)

(72) Inventor: Jared Hendricks, Draper, UT (US)

(21) Appl. No.: 13/747,361

(22) Filed: Jan. 22, 2013

Related U.S. Application Data
(60) Provisional application No. 61/588,510, filed on Jan. 19, 2012.

(51) Int. Cl. F16B 2/20; B65H 75/38

(52) U.S. Cl. CPC F16B 2/20; B65H 75/38
USPC 242/406; 248/305

(57) ABSTRACT

The present disclosure is drawn to a releasable clip for attachment to a spool for holding decorations that allows the spool to be attached to a support structure when hanging or removing decorations, comprising: an attachment portion including an overhang operable to attach to the support structure; and a releasable attachment portion operable to releasably attach to the spool, the releasable attachment portion including a releasable mechanism that interfaces with the spool and an extension structure that extends from the releasable attachment portion beyond the circumference of a side member of the spool when attached to the spool.

### PRIORITY DATA

The present application claims the benefit of U.S. Provisional Patent Application No. 61/588,510, filed on Jan. 19, 2012, the entirety of which is incorporated herein by reference.

### BACKGROUND

During storage, when not in use, decorations can be conveniently kept free of entanglement by wrapping them around a reel or spool. For example, traditional spools are available for use with Christmas lights. Such spools can be orientated on the ground where the lights can be pulled from the spool, the spool rotating to allow the lights to unwind therefrom. While the base provides stability, such spools can require constant repositioning as the sting of lights is affixed to a decorative structure. Alternately, some spools can be hung from a ladder or other structure where the spool is repositioned as the ladder is repositioned. However, while these spools are more mobile, such spools lack stability and can swing freely causing entanglement balance issues.

### SUMMARY

A releasable clip for attachment to a spool for holding decorations is provided. The spool can be attached to a support structure when hanging or removing decorations. The releasable clip can comprise an attachment portion including an overhang operable to attach to a support structure; and a releasable attachment portion operable to releasably attach to the spool. The releasable attachment portion can include a releasable mechanism that interfaces with the spool and an extension structure that extends from the releasable attachment portion to beyond an outer circumference of a side member of the spool when attached to the spool.

Additionally, a method of winding or unwinding decoration about a spool can comprise attaching a releasable clip, as disclosed herein, to a spool, the spool comprising opposing side members attached at a central support structure having a central axis thereby creating a central region about the central axis, the central region at least partially confined by the side members and operable for wrapping the decoration therearound; clipping the spool to a support structure; winding the decoration onto the spool to allow removal from a decorative structure or unwinding the decoration from the spool for attachment of the decoration to a decorative structure.

Further, a system for unwinding, winding, and/or storing a decoration can comprise a releasable clip, as disclosed herein; and a spool comprising opposing side members attached at a central support structure having a central axis thereby creating a central region about the central axis, the central region at least partially confined by the side members and operable for wrapping the decoration therearound; where the releasable clip is releasably attached to the spool.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIGS. 1A-1C provide a front perspective (A); a back perspective (B); and a side perspective (C) of a clip in accordance with embodiments of the present disclosure;

FIG. 2 provides an expanded view of a releasable attachment portion of a clip in accordance with embodiments of the present disclosure; and

FIG. 3 provides a clip attached to a spool in accordance with embodiments of the present disclosure; and

FIG. 4 depicts a flow chart of a method in accordance with embodiments of the present disclosure;

Reference will now be made to the exemplary embodiments illustrated, and specific language will be used herein to describe the same. It will nevertheless be understood that no limitation of the scope of the invention is thereby intended.

### DETAILED DESCRIPTION

The following detailed description of representative embodiments of the present disclosure makes reference to the accompanying drawings, which form a part hereof and in which are shown, by way of illustration, various representative embodiments in which the teachings of the disclosure can be practiced. While these embodiments are described in sufficient detail to enable those skilled in the art to practice the disclosure, it should be understood that other embodiments can be realized and that various changes can be made to the disclosure without departing from the spirit and scope of the present invention. As such, the following detailed description is not intended to limit the scope of the disclosure as it is claimed, but rather is presented for purposes of illustration, to describe the features and characteristics of the present disclosure, and to sufficiently enable one skilled in the art to practice the disclosure. Accordingly, the scope of the present invention is to be defined by the appended claims.

The present disclosure provides a clip that can be attached to a spool providing significant advantages over the prior art. The present clip provides stability, portability, and interchangeability previous unattainable with prior art spools. Notably, prior art spooling systems do not provide both stability and portability with unhindered winding and unwinding capabilities. The present clip can allow attachment of a spool to a support structure in an orientation and height that facilitates winding and unwinding operations of decorations without entanglement. Particularly, the present clip allows a spool to be located in close proximity to the elevation of the decorations while maintaining stability of the spool. Such a combination of properties can provide more efficient winding and unwinding operations of the spool. Additionally, efficiency can be further increased with the present releasable mechanism that allows multiple spools to be changed out during dispensing of the decorations (or during removal of the decorations).

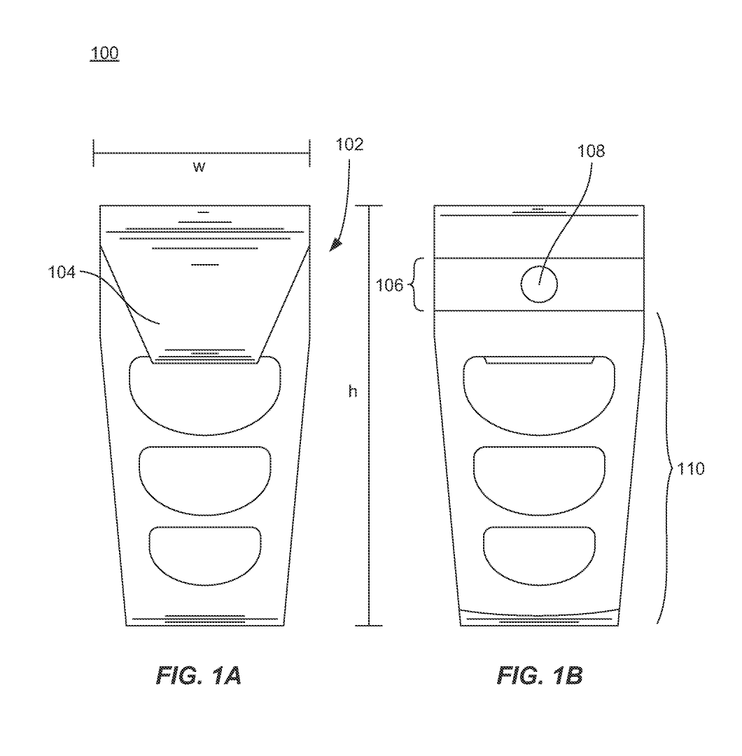

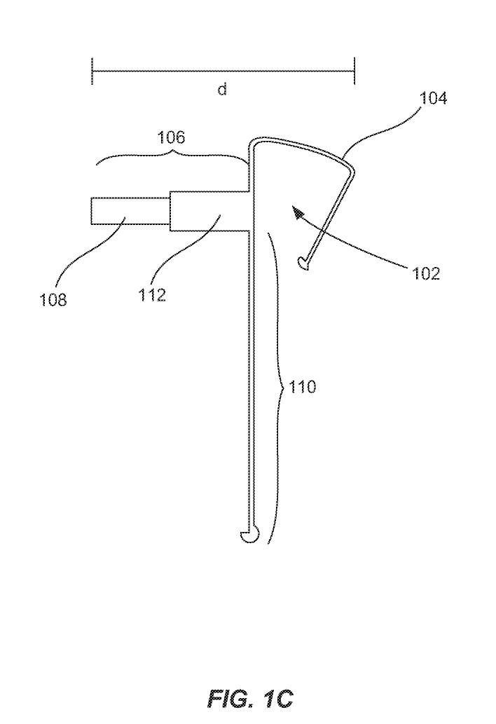

Referring now to FIGS. 1A and 1B, a releasable clip 100 for attachment to a spool for holding decorations that allows the spool to be attached to a support structure when attaching decorations to a decorative structure can include an attachment portion 102 including an overhang 104 configured to attach to the support structure; and a releasable attachment portion 106 configured to releasably attach to the spool. The releasable attachment portion can include a releasable mechanism 108 that interfaces with the spool and an extension structure 110 that extends from the attachment portion 102 to at least the outer circumference of a side member of the spool when attached to the spool. In some cases, the extension structure can extend from the attachment portion to a point beyond the outer circumference of a side member of the spool when attached to the spool. Additionally, in some aspects the attachment portion can be rotatably coupled to a spool.

Referring now to FIG. 1C, a side profile of a clip is depicted. In one embodiment as shown, the releasable attachment portion 106 can include a spacer 112 configured to distance a spool from the clip sufficient to allow rotation of the spool without substantial interference from the clip. As discussed herein, the spacer can be configured to have differing mechanical properties than the remainder of the clip. In one embodiment, the spacer can be rigid.

As used herein, “decorative structure” refers to a building exterior, a building interior, a natural or seemingly natural (i.e. artificial) object such as a tree or bush, an outdoor setting, and the like that can have decorations placed or hung thereon.

As used herein, “overhang” refers to a protruding portion of the releasable clip that extends outward and downward from the releasable attachment portion of the releasable clip. The overhang can facilitate attachment of the releasable clip to a support structure.

As used herein, “spool” and “reel” can be used interchangeable and generally refer to flanged cylindrical structures that allow for the holding and/or storage of a decoration and that can be rotated to unwind or wind the decoration therefrom. In one embodiment, a spool can comprise opposing side members attached at a central support structure having a central axis thereby creating a central region about the central axis, the central region at least partially confined by the side members and operable for wrapping the decoration therearound.

As used herein, “decoration” refers to an object generally having an aesthetic value used to decorate a building exterior, a building interior, a natural or seemingly natural object such as a tree or bush, an outdoor setting, and the like. Generally, the decoration can be substantially linear such that it can be wound or unwound from a spool. In one example, the decoration can be a Christmas decoration, and in one aspect, the decoration can be a string of lights.

Generally, the clip can vary in size. The clip, including differing portions and elements therein, can be sized based on the spool and support structure that the spool is attached via the clip. For example, for larger spools, the clip can be larger or portions of the clip can be made larger to accommodate the spool. Specifically, for example, the spacer group of the releasable attachment portion can extend further for a larger spool as compared to a smaller spool. Additionally, the extension structure may extend further for a larger spool than a smaller spool. Further, the entire clip may have dimensions that are larger for a larger spool as compared to a clip used with a smaller spool. The clip can also be sized to the support structure. For example, the attachment portion may be wider or larger to accommodate a larger support structure, e.g. when attaching to a rung of a larger ladder. Such an attachment portion can include a broader overhang that can improve stability for the larger spool.

In one embodiment, the clip can have a height h (as shown in FIGS. 1A,B) of about 6 inches to 2 feet, and in one aspect, can have a height of about 5 inches to 10 inches. In one embodiment, the clip can have a width w (as shown in FIGS. 1A,B) of about 2 inches to 12 inches, and in one aspect, can be from about 6 inches to 12 inches, and in another aspect, can be from about 2 inches to about 4 inches. Additionally, as shown in FIGS. 1A,B, the width of the clip can taper from the top of the clip to the bottom of the clip, although this is not required. The taper can be for decorative purposes, or the taper can have a functional and/or structural benefit. Such tapering can be modified and the present illustration is not limiting. In one embodiment, the clip can have a depth d (as shown in FIG. 1C) ranging from about 2 inches to about 12 inches, and in one aspect, can be from about 3 inches to about 4 inches.

The releasable clip disclosed herein can be manufactured from any type of material. The material choice can be based on a number of factors including durability, resiliency, strength, etc. In one embodiment, the clip can comprise a material including metals or metal alloys, polymeric materials, wood or wood-containing materials, ceramics, cellulosic materials, and combinations thereof. In one example, the clip can comprise a polymeric material. Examples of polymeric materials include thermosetting plastics and thermoplastics. As such, in one embodiment, the polymeric material can include acrylics, cellulose acetates, cyclic olefin copolymers, vinyl acetates, vinyl alcohols, fluoroplastics, polyacrylates, polyamides, polycarbonates, polyketones, polyesters, polyethylenes, polypropylenes, polystyrenes, polyurethanes, polystyrenes, polyvinyl acetates, polyvinyl chlorides, polyimides, combinations thereof, melamine resins, epoxy resins, and mixtures thereof.

Notably, the entire clip need not be manufactured from a single material. In one embodiment, the clip can be manufactured from at least two types of materials. In another embodiment, the clip can be manufactured from a single type of material or a single material.

Generally, the clip can be constructed to provide desired qualities. For example, in one embodiment, the attachment portion can be resilient. In another example, the extension structure can be resilient. In still another example, the releasable mechanism can be rigid. As used herein, “resilient” refers to a component's ability to return to its original form or position after being stored or when being used in normal operation. Such a construction can be accomplished by using different materials or can be accomplished by using a single material with differing structural components to provide varying mechanical properties. For example, a clip can be manufactured from a resilient and flexible polymeric material that provides flexibility and resiliency to the attachment portion and extension structure, but having increased material about the releasable mechanism (e.g., using increased thickness, stiffening members, internal cross-members, etc.) to provide increased rigidity.

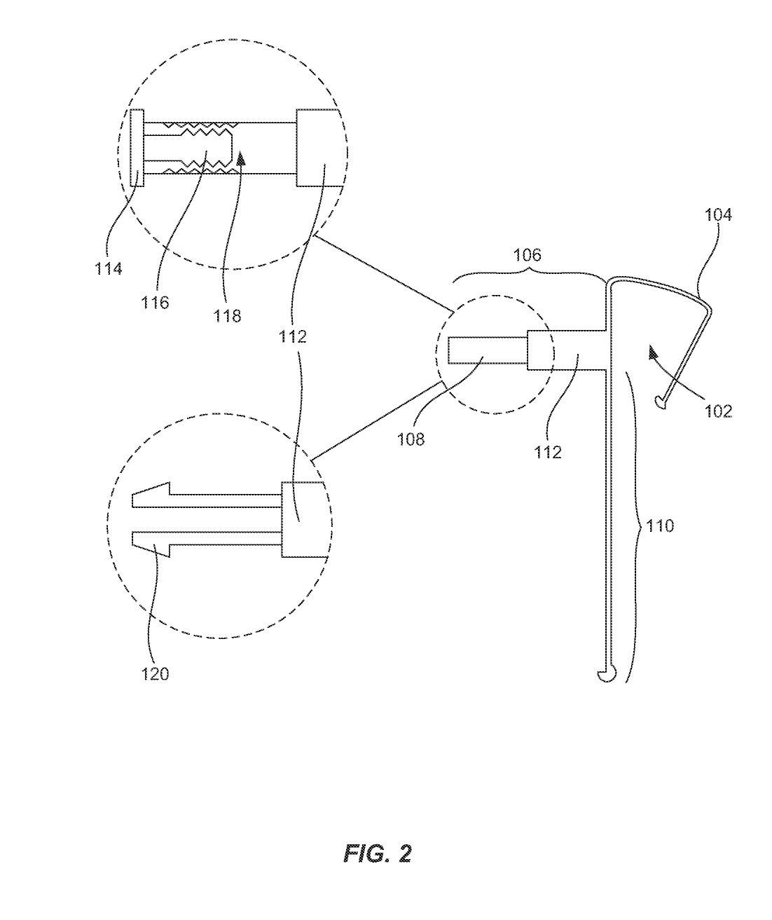

Referring now to FIG. 2, a non-limiting example of a side profile of a clip with an expanded view of the reliable mechanism 108 is depicted. In one embodiment, the releasable mechanism can comprise a bolt 114 having a thread on one end 116 thereof and the clip having a matching threaded hollow 118 for accepting the thread on the end of the bolt. In another embodiment, the releasable mechanism and the clip are a single molded structure and the releasable mechanism is configured as a quick release mechanism. As shown in FIG. 2, one non-limiting type of quick release mechanism can be a pinchable retaining clip 120 having a pinch release function. Such a quick release mechanism can be advantageous in that no tools are required and the release and subsequent attachment can be achieved using a single hand. However, it is understood that any number or quick release mechanisms can be used in conjunction with the present clip and that the presently shown quick release mechanism is not limiting.

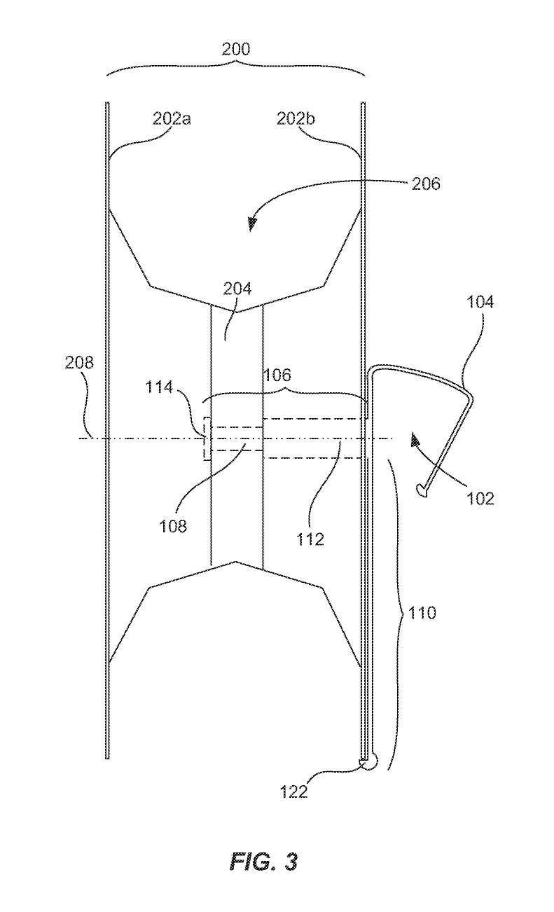

Referring now to FIG. 3, a clip attached to a spool 200 is depicted. In one embodiment, the spool comprises opposing side members 202a,b attached at a central support structure 204 thereby creating a central region 206 about a central axis 208, the central region at least partially confined by the side members and operable for wrapping the decoration therearound. In one embodiment, the releasable mechanism can extend through the spool at the central axis and attached thereto. Notably, as depicted, the spacer group 112 can provide clearance between the spool and the clip such that the spool can rotate freely allowing unhindered operation thereof. In one embodiment, the extension structure 110 can include an overhang guard 122 that is positioned at an outer circumference of a side member of the spool when the clip is attached to the spool. The overhang guard can facilitate unhindered operation of the spool by reducing interference from objects to which the clip is attached. For example, when the clip is attached to the belt of an individual, the overhang guard can reduce contact between the spool and the pants or legs of the individual. Alternately, when the clip is attached to a ladder, the overhang guard can reduce contact between the spool and the rungs or rails of the ladder. In one example, the overhang guard can extend in a length equal to or greater than a thickness of a side member 202b of the spool. In some embodiments, the overhang guard can wrap around the side of the spool

Generally, the overhang of the clip facilitates the attachment of the clip to a support structure at a location where the decorations are located, or are to be located. In one embodiment, the support structure can be a decorative structure, e.g., a gutter on a building. In another embodiment, the overhang can be a hook that is biased to grip the support structure to which it is attached. As used herein, “hook” refers to a protruding portion of a releasable clip that is curved or bent in both a horizontal and vertical plane used to suspend or fasten the spool to a support structure. In one embodiment, the support structure can be a belt. In another embodiment, the support structure can be a gutter. In still another embodiment, the support structure can be a ladder. In yet another embodiment, the support structure can be a man basket. As used herein, “grip” refers to a lateral force from an overhang or hook generally directed towards a spool to stabilize the spool during use.

The presently disclosed clips can be used in conjunction with various spools as known in the art. As discussed herein, generally the spool comprises opposing side members attached to a central support structure thereby creating a central region about a central axis, the central region at least partially confined by the side members and operable for wrapping a decoration therearound. As such, existing spools of the art may be modified to accept the releasable attachment portion as described herein. In one embodiment, the spool can comprise a material including metals or metal alloys, polymeric materials, wood or wood-containing materials, ceramics, cellulosic materials, and combinations thereof. In one example, the spool can comprise a polymeric material, including disclosed herein. Notably, the entire spool need not be manufactured from a single material. In one embodiment, the spool can be manufactured from at least two types of materials. In another embodiment, the spool can be manufactured from a single type of material or a single material. In one specific aspect, the spool and the clip can be manufactured from the same material. The size of the spool can vary. In one embodiment, the spool is configured to hold from about 10 feet to 200 feet of decorations. In one aspect, the spool can hold 50 feet to 100 feet.

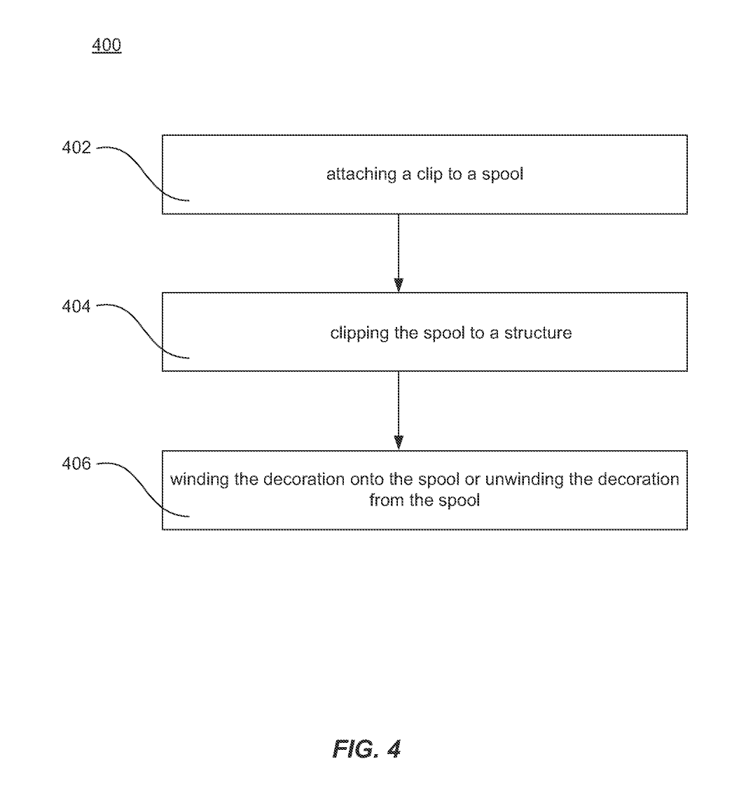

Referring now to FIG. 4, a method 400 of winding or unwinding decoration about a spool can comprise attaching a clip, as disclosed herein, to a spool 402, the spool comprising opposing side members attached at a central support structure having a central axis thereby creating a central region about the central axis, the central region at least partially confined by the side members and operable for wrapping the decoration therearound; clipping the spool to a support structure 404; and winding the decoration onto the spool to allow removal from a decorative structure or unwinding the decoration from the spool for attachment of the decoration to a decorative structure 406.

Further, a system for unwinding, winding, and/or storing a decoration can comprise a clip as disclosed herein and a spool, wherein the clip is releasably attached to the spool. The system can further comprise a plurality of spools. Such a system can provide efficient addition of decorations to a decorative structure or removal therefrom as the present clip can be used interchangeably with each spool. Further, as the clip is removed from the spool, the spool can more easily stored as the spool can be stored substantially flat and stacked with other spools in a stable manner.

It is be noted that, as used in this specification and the appended claims, the singular forms “a,” “an,” and “the” include plural referents unless the context clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. Additionally, a numerical range with a lower end of “0” can include a sub-range using “0.1” as the lower end point.

The above detailed description describes the disclosure with reference to specific representative embodiments. However, it will be appreciated that various modifications and changes can be made without departing from the scope of the present disclosure as set forth in the appended claims. The detailed description and accompanying drawings are to be regarded as merely illustrative, rather than as restrictive, and all such modifications or changes, if any, are intended to fall within the scope of the present disclosure as described and set forth herein. More specifically, while illustrative representative embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. Also, any steps recited in any method or process claims can be executed in any order and are not limited to the order presented in the claims.

What is claimed is:

1. A releasable clip for attachment to a spool for holding decorations that allows the spool to be attached to a support structure when hanging or removing decorations, comprising:
an attachment portion including an overhang operable to attach to the support structure; and
a releasable attachment portion operable to releasably attach to the spool, the releasable attachment portion including a releasable mechanism that interfaces with the spool and an extension structure that extends from the releasable attachment portion to beyond an outer circumference of a side member of the spool when attached to the spool.

2. The releasable clip of claim 1, wherein the decoration is a string of lights.

3. The releasable clip of claim 1, wherein the clip comprises a material selected from the group consisting of: metals or metal alloys, polymeric materials, wood or wood-containing materials, ceramics, cellulosic materials, and combinations thereof.

4. The releasable clip of claim 1, wherein the clip comprises a polymeric material.

5. The releasable clip of claim 1, wherein the clip is resilient and the releasable mechanism is rigid.

6. The releasable clip of claim 1, wherein the releasable mechanism includes a spacer configured to distance the spool from the releasable clip sufficient to allow rotation of the spool without substantial interference from the releasable clip.

7. The releasable clip of claim 6, wherein the spacer is rigid.

8. The releasable clip of claim 1, wherein the releasable mechanism extends through a central axis of the spool.

9. The releasable clip of claim 1, wherein the releasable mechanism comprises a bolt having a thread on one end thereof and the releasable clip having a matching threaded hollow for accepting the thread on the end of the bolt.

10. The releasable clip of claim 1, wherein the releasable mechanism and the clip are a single molded structure and the releasable mechanism is configured as a quick release mechanism.

11. The releasable clip of claim 10, wherein the quick release mechanism has a pinch release function.

12. The releasable clip of claim 1, wherein the extension structure includes an overhang guard that is positioned at an outer circumference of a side member of a spool when the releasable clip is attached to the spool.

13. The releasable clip of claim 12, wherein the overhang guard extends around at least a portion of a thickness of a side member of a spool when the releasable clip is coupled to the spool.

14. The releasable clip of claim 1, wherein the overhang is biased to grip the support structure when attached thereto.

15. The releasable clip of claim 1, wherein the support structure is a gutter or a ladder.

16. A method of winding or unwinding decoration about a spool, comprising:
attaching the releasable clip of claim 1 to a spool, the spool comprising opposing side members attached at a central support structure having a central axis thereby creating a central region about the central axis, the central region at least partially confined by the side members and operable for wrapping the decoration therearound;
clipping the spool to a support structure; and
winding the decoration onto the spool to allow removal from a decorative structure or unwinding the decoration from the spool for attachment of the decoration to a decorative structure.

17. The method of claim 16, further comprising removing the clip from the spool and attaching the clip to a subsequent spool.

18. The method of claim 16, wherein the decoration is a string of lights.

19. A system for unwinding, winding, and/or storing a decoration, comprising:
the releasable clip of claim 1; and
a spool comprising opposing side members attached at a central support structure having a central axis thereby creating a central region about the central axis, the central region at least partially confined by the side members and operable for wrapping the decoration therearound;
wherein the releasable clip is releasably attached to the spool.

20. The system of claim 19, further comprising a plurality of spools.
